(19) United States
(12) Patent Application Publication
(10) Pub. No.: US 2022/0286040 A1
(43) Pub. Date: Sep. 8, 2022

(54) POWER ELECTRONIC CONVERTER

(71) Applicants: Wolfgang BAECK, Sankt Valentin (AT); Michael NEUDORFHOFER, Sankt Valentin (AT); Gerd SCHLAGER, Sankt Valentin (AT); Lakshmi Varaha IYER, Troy, MI (US); Philip KORTA, Troy, MI (US); MAGNA INTERNATIONAL INC., Aurora (CA)

(72) Inventors: Wolfgang BAECK, Sankt Valentin (AT); Michael NEUDORFHOFER, Sankt Valentin (AT); Gerd SCHLAGER, Sankt Valentin (AT); Lakshmi Varaha IYER, Troy, MI (US); Philip KORTA, Troy, MI (US)

(21) Appl. No.: 17/635,904

(22) PCT Filed: Aug. 14, 2020
(86) PCT No.: PCT/US2020/046327

§ 371 Date: Feb. 16, 2022

Related U.S. Application Data
(60) Provisional application No. 62/887,836, filed on Aug. 16, 2019.

(51) Int. Cl. H02M 1/15; H02M 1/00; H02M 3/158

(52) U.S. Cl. CPC H02M 1/15; H02M 1/0058; H02M 1/0043; H02M 3/1586

(57) ABSTRACT

A power electronic converter supplies DC output power to an output bus for supplying a load, such as a battery. The power electronic converter includes a DC link capacitor configured to provide a DC link voltage with a ripple of 80 V peak-to-peak. The power electronic converter also includes a DC/DC stage having a DC/AC converter that includes one or more switches to selectively conduct current from the DC link bus to supply an AC power to a transformer. The switches of the DC/AC converter are mounted to an insulated metal substrate that is in thermal contact with a transformer housing for dissipating heat therefrom. A controller controls one or more switches of the DC/AC converter and varies a switching frequency responsive to the ripple of the DC link voltage.

### CROSS-REFERENCE TO RELATED APPLICATIONS

This PCT International Patent application claims the benefit of and priority to U.S. Provisional Patent Application Ser. No. 62/887,836 filed on Aug. 16, 2019, and titled “Power Electronic Converter,” the entire disclosure of which is hereby incorporated by reference.

### BACKGROUND

Power electronic converters have numerous practical applications including regulating flow of electrical current in fixed or mobile applications. Examples of such power electronic converters include alternating current (AC) to direct current (DC) converters (or AC/DC converters, for short), DC to AC converters (or DC/AC converters, for short), and DC to DC converters (or DC/DC converters, for short). Each type of power electronic converter uses one or more power electronic switches to convert an input power to an output power. Example applications for power electronic converters include power supplies for electronics or appliances, motor drives, and battery chargers.

### SUMMARY

The present disclosure provides a power electronic converter comprising a DC link bus including a DC positive node and a DC negative node and defining a DC link voltage therebetween. The DC link voltage has a ripple as a periodic variation. The power electronic converter includes a DC link capacitor connected between the DC positive node and the DC negative node to regulate the ripple of the DC link voltage. The power electronic converter also includes a switching stage including a switch configured to selectively conduct current from the DC link bus. The power electronic converter also includes a controller configured to control the switch and to vary at least one of a switching frequency or a duty cycle or a phase shift of the switch responsive to the ripple of the DC link voltage.

The present disclosure also provides a method of operating a power electronic converter. The method comprises the steps of commanding a switch to selectively conduct current from a DC link bus to convert a DC power from the DC link bus; and varying at least one of a switching frequency or a duty cycle or a phase shift of the switch responsive to a ripple of a DC link voltage upon the DC link bus.

The present disclosure also provides a power electronic converter comprising a switching stage including a switch configured to selectively conduct current from the a link bus. The power electronic converter also includes a transformer in electrical communication with the switching stage and having a transformer housing. The switch is mounted to an insulated metal substrate in thermal contact with a housing of the transformer for conducting heat from the switch to the transformer housing.

### BRIEF DESCRIPTION OF THE DRAWINGS

Further details, features and advantages of designs of the invention result from the following description of embodiment examples in reference to the associated drawings.

FIG. 1 shows a schematic block diagram of a power electronic converter in accordance with some embodiments of the present disclosure;

FIG. 2 shows a functional diagram illustrating operation of a DC/DC stage in accordance with some embodiments of the present disclosure;

FIG. 3 shows a side view of a power electronic converter in accordance with some embodiments of the present disclosure;

FIG. 4 shows a side view of a power electronic converter in accordance with some embodiments of the present disclosure;

FIG. 5 shows a perspective view showing temperatures of various parts of a power electronic converter in accordance with some embodiments of the present disclosure;

FIG. 6 shows a top view showing temperatures of various parts of a power electronic converter in accordance with some embodiments of the present disclosure;

FIG. 7 shows a front side view showing temperatures of various parts of a power electronic converter in accordance with some embodiments of the present disclosure;

FIG. 8 shows a side view showing temperatures of various parts of a power electronic converter in accordance with some embodiments of the present disclosure; and

FIG. 9 shows a flow chart of steps in a method of operating a power electronic converter in accordance with some embodiments of the present disclosure.

### DETAILED DESCRIPTION

Referring to the drawings, the present invention will be described in detail in view of following embodiments. Example embodiments of a power electronic converter 10 in the form of a DC to DC converter. However, aspects of the disclosure may also be embodied within other types of power electronic converters, such as an AC to DC converter or a DC to AC converter or an AC to AC converter.

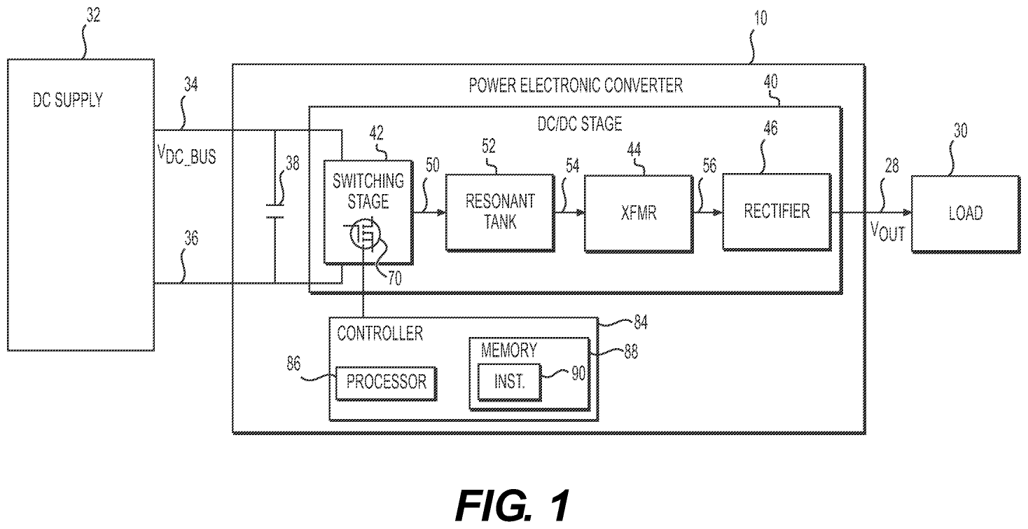

FIG. 1 shows a schematic diagram of a power electronic converter 10 which is configured to provide DC output power to an output bus 28 for supplying a load 30, such as a battery, using DC power from a DC supply 32, which may be, for example, a battery or a AC/DC converter for receiving an AC current e.g. from a grid or utility line power supply. The load 30 may include one or more different devices such as, for example, a battery, a DC motor, or another power converter for converting the DC output power to another form, such as an AC power or a DC power having a different voltage than the DC output power on the output bus 28.

Still referring to FIG. 1, a DC supply 32 supplies the power electronic converter 10 with DC power via a DC link bus 34, 36. Specifically, the DC link bus 34, 36 includes a DC positive node 34 and a DC negative node 36 defining a DC link voltage V_{DC_BUS} therebetween. A DC link capacitor 38 is connected between the DC positive node 34 and the DC negative node 36 for regulating and stabilizing the DC link voltage V_{DC_BUS}. The power electronic converter 10 also includes a DC/DC stage 40 having a switching stage 42 that supplies an AC power to a transformer 44. The DC/DC stage 40 also includes a rectifier 46 configured to convert AC power from a secondary side of the transformer 44 to energize the output bus 28 with DC power. More specifically, the switching stage 42 energizes a first internal bus 50 with AC power by selectively switching current from the DC link bus 34, 36. A resonant tank 52 is coupled to the first internal bus 50 and changes the AC voltage from the first internal bus 50 to a different AC voltage on a second internal bus 54. In some embodiments, the resonant tank 52 has an inductor-inductor-capacitor (LLC) configuration, which may include a resonant inductor in series with a resonant capacitor and coupled to the switching stage 42.

The transformer 44 includes a primary winding (not shown) coupled to the second internal bus 54 and a secondary winding (not shown) coupled to a third internal bus 56. The transformer 44 provides isolation and/or a change in AC voltage between the second internal bus 54 and third internal bus 56. The rectifier 46 is coupled to the third internal bus 56 and converts AC power therefrom to the DC output power upon the output bus 28. The first internal bus 50 thus carries the AC power that is converted to a different voltage level upon the third internal bus 56 by a combination of the resonant tank 52 and the transformer 44. In some embodiments, and particularly where the DC/DC Stage 40 includes a resonant tank 52 with an inductor-inductor-capacitor (LLC) configuration, a switching frequency of the switch 70 may be varied in response to the ripple of the DC link voltage V_{DC_BUS} upon the DC link bus 34, 36.

The rectifier 46 may include four diodes connected as a bridge rectifier. However, the rectifier 46 may have other configurations, such as a single diode, a wave rectifier, and/or one or more switches configured to provide active rectification, which may also be called synchronous rectification (SR).

In some embodiments, the DC link voltage V_{DC_BUS} has a ripple as a periodic variation. The ripple may be sinusoidal, although other waveform shapes are possible. In conventional converter designs, ripple is sought to be minimized. However, in some embodiments of the present disclosure, the ripple of the DC link voltage V_{DC_BUS} is allowed to have a greater amplitude than in conventional designs. In some embodiments, for example, the DC link voltage V_{DC_BUS} may have a peak-to-peak ripple of 80 V. The size of the DC link capacitor 38 is a main factor in determining the amplitude of the ripple of the DC link voltage V_{DC_BUS}. In some embodiments of the present disclosure, the DC link capacitor 38 has a value of 100 μF to provide the peak-to-peak ripple of 80 V, wherein a conventional design may have a value of 500 μF to provide the peak-to-peak ripple that is substantially less than 80 V.

Still referring to FIG. 1, the power electronic converter 10 includes the switching stage 42 having one or more switches 70, that are configured to selectively conduct current from the DC link bus 34, 36 to convert the DC power from the DC link bus 34, 36 to an output DC power having an output voltage Vₒᵤₜ different from the DC link voltage V_{DC_BUS}. The power electronic converter 10 also includes a controller 84 configured to control the switches 70 and to vary at least one of a switching frequency or a duty cycle or a phase shift of the switch responsive to the ripple of the DC link voltage V_{DC_BUS}. More specifically, the controller 84 includes a processor 86 and a machine readable storage memory 88 holding instructions 90 for execution by the processor 86 to cause the processor 86 to command one or more of the switches 70 selectively conduct current from the DC link bus 34, 36 responsive to the ripple of the DC link voltage V_{DC_BUS}. The processor 86 may include one or more of a microprocessor, a microcontroller, a programmable gate array, or an application specific integrated circuit (ASIC). The switches 70 of the switching stage 42 may be negative type Metal Oxide Semiconductor (NMOS) type field effect transistors (FETs), as shown. However, one or more of the switches may 70 may be different types of devices, such as another type of FET, a junction transistor, or a triac.

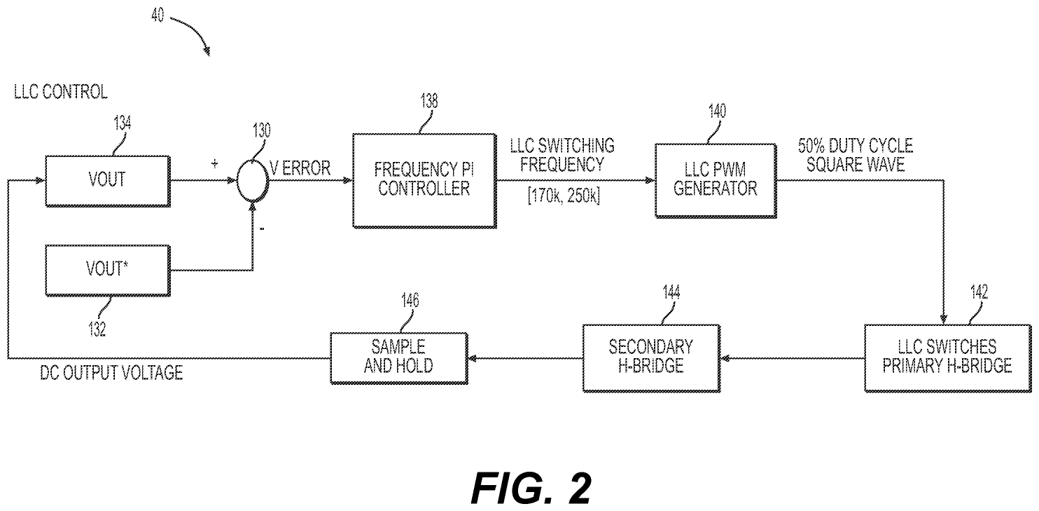

FIG. 2 shows a functional diagram illustrating operation of a DC/DC stage 40 in accordance with some embodiments of the present disclosure. Specifically, FIG. 2 shows a summing block 130 configured to subtract a reference voltage 132 from an actual output voltage signal 134 to produce a voltage error signal Vₑᵣᵣₒᵣ. The voltage error signal Vₑᵣᵣₒᵣ is sent to a frequency proportional-integral (PI) controller 138 that generates an LLC switching frequency based upon the voltage error signal Vₑᵣᵣₒᵣ over time. In some embodiments the controller 84 is configured to vary the switching frequency of the switches 70 based upon the voltage error signal Vₑᵣᵣₒᵣ. In some embodiments the controller 84 is configured to vary the switching frequency of the switches 70 by at least 40 kHz above or below a nominal frequency. For example, the LLC switching frequency may have a nominal frequency of 210 kHz, and the LLC switching frequency may vary between 170 kHz and 250 kHz (i.e. by +/−40 kHz), although other frequencies may be used. The LLC switching frequency is provided to an LLC PWM Generator 140 that generates a pulse-width modulated (PWM) signal. The pulse-width modulated (PWM) signal may be configured as a 50% duty cycle square wave. The pulse-width modulated (PWM) signal is provided to a primary H-Bridge which may include, for example, the switching stage 42 described above with reference to FIG. 1. The pulse-width modulated (PWM) signal is provided to a primary H-Bridge 142. The pulse-width modulated (PWM) signal is also provided to a secondary H-Bridge 144. The DC/DC stage 40 may also include an output voltage monitor 146 that may be configured to periodically sample and hold a value of the output voltage V_{OUT} to generate the actual output voltage signal 134.

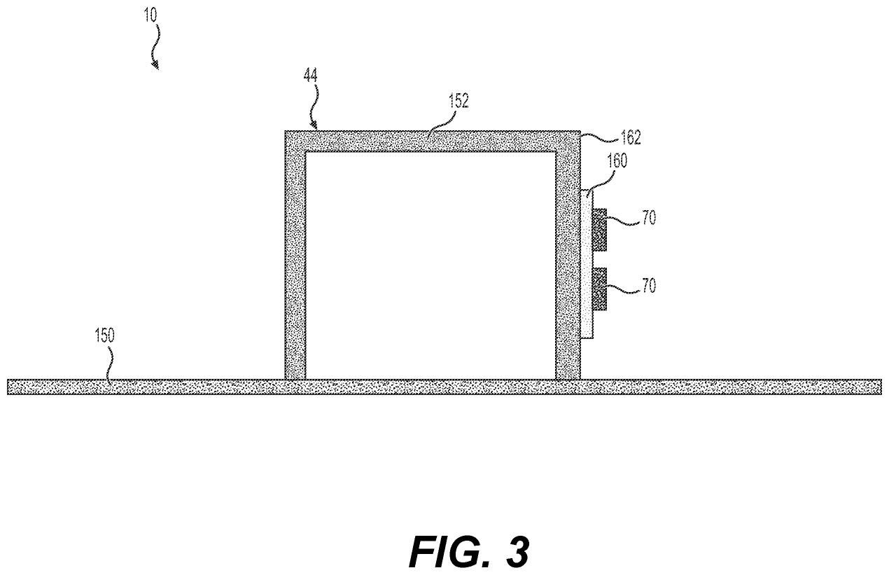

FIG. 3 shows a side view of a power electronic converter 10 in accordance with some embodiments of the present disclosure. Specifically, FIG. 3 shows a main board 150, such as a printed circuit board, extending in a flat plane and holding a transformer housing 152 that includes the transformer 44. The transformer housing 152 may include an enclosure of metal, such as aluminum, or another heat conductive material. The switches 70 of the DC/DC stage 40 are each mounted to an insulated metal substrate (IMS) 160 that is in thermal contact with the transformer housing 152. For example, one or more of the switches 70 may be soldered to the insulated metal substrate 160. Waste heat from operation of the switches 70 may, therefore, be conducted through the IMS 160 and to the transformer housing 152, from which the heat may be removed. The heat may be further dissipated from the transformer housing 152 by one or more heat sinks in thermally-conductive contact with the transformer housing 152.

In some embodiments, and as shown in FIG. 3, the insulated metal substrate 160 is disposed on a side wall 162 of the transformer housing 152 perpendicular to the main board 150. This configuration may simplify wiring connections between the main board 150 and the switches 70 on the insulated metal substrates 160, thereby making the assembly more compact.

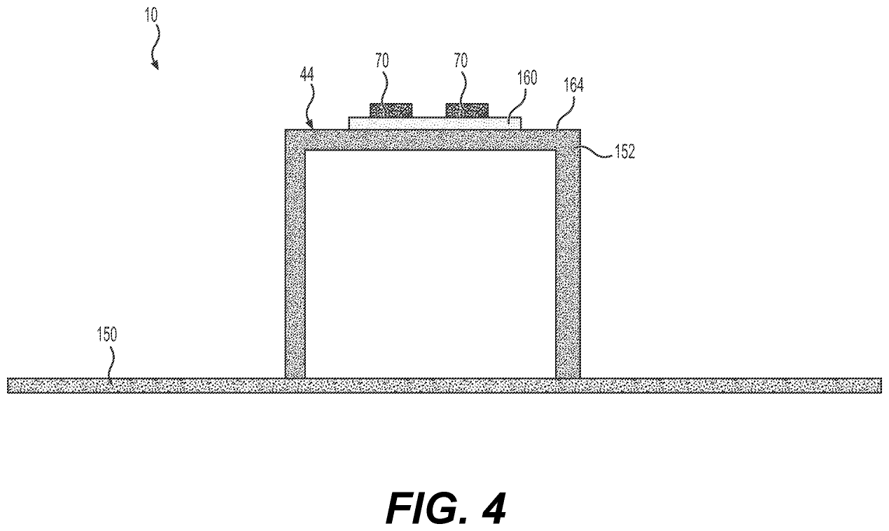

In some embodiments, and as shown in FIG. 4, the insulated metal substrate 160 is disposed on an upper portion 164 of the transformer housing 152 spaced apart from and parallel to the main board 150.

The power electronic converter 10 of the present disclosure may be significantly smaller and/or lighter weight than conventional converters that have similar power converting capacity. These savings may be realized by a combination of: 1) reducing the size of the DC link capacitor 38 and 2) attaching the IMS 160 to the transformer housing 152.

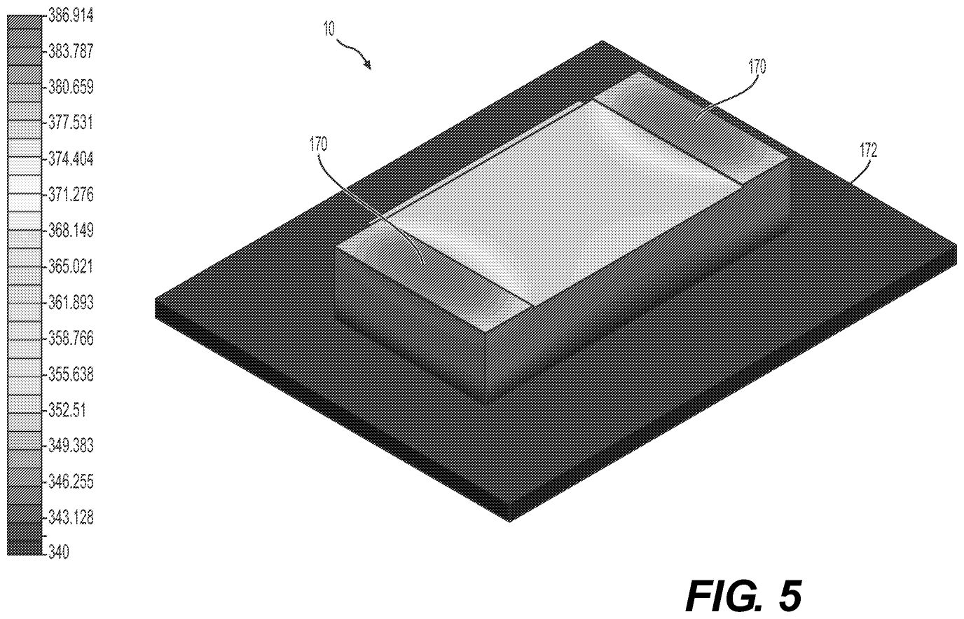

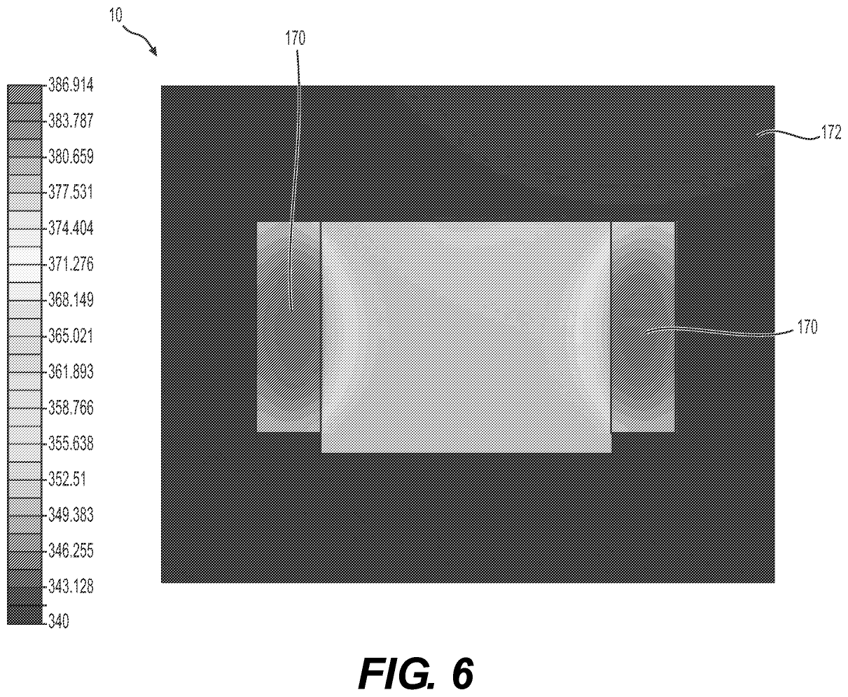

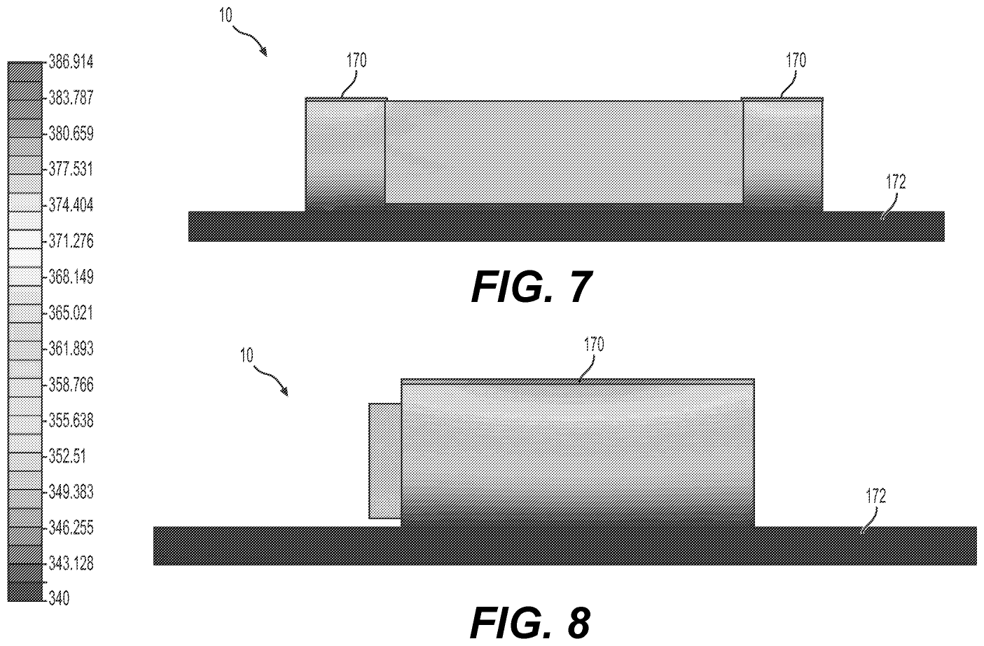

FIGS. 5-8 each show different views of the power electronic converter 10 in accordance with some embodiments. Specifically, FIGS. 5-8 illustrate different temperatures from hottest regions 170 at and/or near the insulated metal substrates 160 to coldest regions at or near the main board 150. FIGS. 5-8 show the maximum temperature happens at the switches 70 (387K=114° C.), which is much lower than a 150 C limit where the switches 70 are Gallium nitride (GaN) devices.

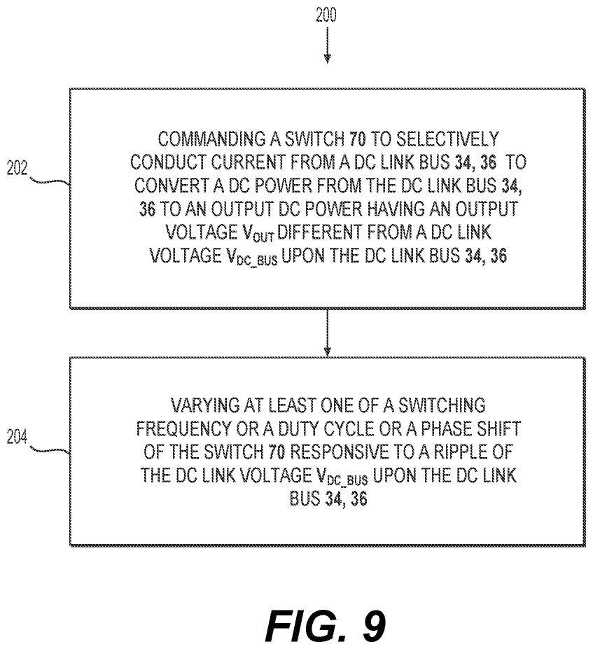

A method 200 of operating a power electronic converter is shown in the flow chart of FIG. 9. The method 200 includes commanding a switch 70 to selectively conduct current from a DC link bus 34, 36 having a DC link voltage V_{DC_BUS} to convert a DC power from the DC link bus 34, 36 to an output DC power having an output voltage V_{OUT} different from the DC link voltage V_{DC_BUS} upon the DC link bus 34, 36 at step 202.

The method 200 also includes varying at least one of a switching frequency or a duty cycle or a phase shift of the switch 70 responsive to a ripple of a DC link voltage V_{DC_BUS} upon the DC link bus 34, 36 at step 204. Step 204 may include varying the switching frequency of the switch 70 by operating the switching frequency at a low frequency less than a nominal frequency in response to the DC link voltage V_{DC_BUS} being less than a nominal voltage, and operating the switching frequency at a high frequency greater than the nominal frequency in response to the DC link voltage V_{DC_BUS} being greater than the nominal voltage.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A power electronic converter, comprising:
a DC link bus including a DC positive node and a DC negative node and defining a DC link voltage therebetween, the DC link voltage having a ripple as a periodic variation;
a DC link capacitor connected between the DC positive node and the DC negative node of the DC link bus to regulate the ripple of the DC link voltage;
a switching stage including a switch configured to selectively conduct current from the DC link bus; and
a controller configured to control the switch and to vary at least one of a switching frequency or a duty cycle or a phase shift of the switch responsive to the ripple of the DC link voltage.

2. The power electronic converter of claim 1, wherein the DC link capacitor has a value of less than 500 uF.

3. The power electronic converter of claim 1, wherein the DC link capacitor has a value of less than 100 uF.

4. The power electronic converter of claim 1, wherein the ripple of the DC link voltage is at least about 80 V peak-to-peak.

5. The power electronic converter of claim 1, wherein the controller is configured to vary the switching frequency of the switch responsive to the ripple of the DC link voltage.

6. The power electronic converter of claim 5, wherein the controller is configured to vary the switching frequency of the switch by at least 40 kHz above or below a nominal frequency.

7. The power electronic converter of claim 5, wherein the controller is configured to vary the switching frequency of the switch from a low frequency less than a nominal frequency in response to the DC link voltage being less than a nominal voltage to a high frequency greater than the nominal frequency in response to the DC link voltage being greater than the nominal voltage.

8. The power electronic converter of claim 1, wherein the controller is configured to vary the duty cycle of the switch responsive to the ripple of the DC link voltage.

9. The power electronic converter of claim 1, wherein the controller is configured to vary the phase shift of the switch responsive to the ripple of the DC link voltage.

10. A method of operating a power electronic converter comprising:
commanding a switch to selectively conduct current from a DC link bus to convert a DC power from the DC link bus; and
varying at least one of a switching frequency or a duty cycle or a phase shift of the switch responsive to a ripple of a DC link voltage upon the DC link bus.

11. The method of claim 10, wherein varying at least one of the switching frequency or the duty cycle or the phase shift of the switch comprises varying the switching frequency of the switch.

12. The method of claim 11, wherein varying the switching frequency of the switch includes operating the switching frequency at a low frequency less than a nominal frequency in response to the DC link voltage being less than a nominal voltage, and operating the switching frequency at a high frequency greater than the nominal frequency in response to the DC link voltage being greater than the nominal voltage.

13. A power electronic converter, comprising:
a switching stage including a switch configured to selectively conduct current from a DC link bus;
a transformer in electrical communication with the switching stage and having a transformer housing; and
wherein the switch is mounted to an insulated metal substrate in thermal contact with the transformer housing for conducting heat from the switch to the transformer housing.

14. The power electronic converter of claim 13, further comprising:
a main board extending in a flat plane and holding the transformer housing; and
wherein the insulated metal substrate is disposed on an upper portion of the transformer housing spaced apart from and parallel to the main board.

15. The power electronic converter of claim 13, further comprising:
a main board extending in a flat plane and holding the transformer housing; and
wherein the insulated metal substrate is disposed on a side wall of the transformer housing perpendicular to the main board.

16. The method of claim 12, wherein the switching frequency of the switch is determined by a proportional-integral (PI) controller based upon the DC link voltage.

17. The method of claim 12, wherein the low frequency is at least 40 kHz below the nominal frequency, and the high frequency is at least 40 kHz above the nominal frequency.

18. The method of claim 12, wherein the nominal frequency is at least 200 kHz.

19. The method of claim 10, wherein varying the at least one of the switching frequency or the duty cycle or the phase shift of the switch includes varying the duty cycle of the switch responsive to the ripple of the DC link voltage.

20. The method of claim 10, wherein varying the at least one of the switching frequency or the duty cycle or the phase shift of the switch includes varying the phase shift of the switch responsive to the ripple of the DC link voltage.
